(19) United States
(12) Patent Application Publication
(10) Pub. No.: US 2008/0182529 A1
(43) Pub. Date: Jul. 31, 2008

(54) RDS/RBDS COMPATIBLE FM TRANSMITTER

(75) Inventor: Tatsuya Mano, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/016,367

(22) Filed: Jan. 18, 2008

(30) Foreign Application Priority Data
Jan. 19, 2007 (JP) JP2007-010803
Jan. 19, 2007 (JP) JP2007-010804

(51) Int. Cl. H04B 1/04

(52) U.S. Cl. 455/113

(57) ABSTRACT

A data generating unit sets a predetermined value to a data item, which can be made as a reference for tuning at a receiver, so as to generate data of RDS/RBDS format. A frequency modulator modulates the frequency of the data of the RDS/RBDS format generated by the data generating unit, and outputs the frequency-modulated data. The data item may be a program type. The program type is set independently of the type of the data transmitted from the FM transmitter. The receiver tunes with the value of the program type set to the predetermined value.

### BACKGROUND OF THE INVENTION

1. Field of the Invention

The present invention relates to an FM transmitter that is compatible with RDS (Radio Data System) or RBDS (Radio Broadcast Data System).

2. Description of the Related arts

In recent years, FM radio stations in Europe or radio stations in the United States transmit additional information such as a text as RDS (Radio Data System) information in Europe or RBDS (Radio Broadcast Data System) information in the United States. When the RDS/RBDS is used, various information pieces, such as the name of the station, genre of music that can currently be received, can be utilized in a receiver of a car radio (Japanese Patent Application (Laid-Open) Nos. H8-256135 and H8-191232).

On the other hand, an FM transmitter that converts an audio signal into a stereo composite signal, frequency-modulates the stereo composite signal using a frequency modulator and outputs the obtained signal, has been known (Japanese Patent Application (Laid-Open) Nos. H9-069729, H10-013370 and H9-312588).

Such FM transmitter is able to transmit the audio signal without using wirings such as RCA cable, and thus is used in transmitting signals between the CD changer of a car audio and the main head unit. Furthermore, hard disc audio equipment, memory audio equipment, portable telephone terminals having music reproducing function are significantly becoming widely used in recent years, and FM transmitter is used to reproduce musical data stored in such compact electronic device from a speaker of a stationary audio component stereo and the like.

Conventionally, a user has manually matched a transmission frequency of an FM transmitter and a reception frequency of a radio tuner (receiver). In this case, the user recognizes the frequency of the FM transmitter, and then, sets this frequency to the radio tuner, which is troublesome. When the transmission frequency of the FM transmitter is overlapped with the other broadcasting station, the user is required to reset the transmission frequency of the FM transmitter and the reception frequency of the radio tuner.

### SUMMARY OF THE INVENTION

The present invention is accomplished in view of the foregoing problem, and its general purpose is to provide an FM transmitter that can facilitate tuning and frequency tuning.

One embodiment of the present invention relates to an FM transmitter that can transmit signal based on a RDS (Radio Data System) format or RBDS (Radio Broadcast Data System) format. This FM transmitter includes a data generating unit that sets a predetermined value to a data item, which can be made as a reference for tuning at a receiver side, and generates data of an RDS/RBDS format, and a frequency modulator that modulates the frequency of the data of the RDS/RBDS format generated at the data generating unit and outputs the frequency-modulated data.

The phrase of “the data item, which can be made as a reference for tuning” means data used for tuning search. It is technically presupposed that, if the receiver sets a certain value to the data item, the frequency having this value as the data item can automatically be extracted.

According to this embodiment, when a predetermined value is input to the data item, instead of the frequency, upon tuning the frequency of the receiver with the transmission frequency, the receiver can automatically tune the channel having the predetermined value in the data item.

The data item may be a program type. When a predetermined value of “news” is set as a program type, for example, tuning is automatically conducted in the FM transmitter if the program type is set to “news” in the receiver.

The program type may be set independently of the type of the data transmitted from the FM transmitter. Specifically, even if the predetermined value of “news” is set, the content of the audio signal transmitted from the FM transmitter is not necessarily a news, but optional. It is different from the broadcasting from a broadcasting station on this point.

The data item may be a music/speech code. The music/speech code may be set independently of the type of the data transmitted from the FM transmitter.

The data generating unit may set a predetermined value in accordance with an instruction from a user. If a user can change the value of the data item in the receiver and the value of the data item in the FM transmitter, it becomes more convenient.

The FM transmitter may be monolithically integrated on a single semiconductor substrate. The term “monolithically integrated” includes the case in which all the components of a circuit are formed on the semiconductor substrate and the case in which the main components of a circuit are monolithically integrated, wherein some resistors or capacitors may be provided at the outside of the semiconductor substrate for adjusting a circuit constant. These circuits are integrated as a single LSI, whereby the circuit area can be reduced.

Another embodiment of the present invention is electronic device. The electronic device includes one of the FM transmitters according to the above-mentioned embodiments, and a host processor that is connected to the FM transmitter through a predetermined bus, acquires the predetermined value, which is designated by a user, and transmits the value to the FM transmitter. The FM transmitter sets the predetermined value, which is designated by a user, to the data item.

Still another embodiment of the present invention relates to a method for automatically tuning in RDS (Radio Data System)/RBDS (Radio Broadcast Data System). In an FM transmitter, this method includes: setting a predetermined value to a data item of RDS/RBDS that can be set to a reference of tuning in a receiver, generating data of RDS/RBDS format to which the predetermined value is set as the data item, and outputting the data of the RDS/RBDS format with the frequency modulated. In an FM receiver, this method includes: receiving a radio wave, and decoding data of RDS/RBDS format so as to extract and tune a channel whose data item, which can be made to be a reference for tuning, has a predetermined value.

According to this embodiment, the data item set in the transmitter and the receiver is matched to the predetermined value, whereby the automatic tuning is made possible.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing an overall structure of electronic device having an FM transmitter mounted thereto according to an embodiment of the present invention;

FIG. 2 is a diagram showing a format of RDS group data; and

FIG. 3 is a circuit diagram of the FM transmitter and a peripheral circuit.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, “state in which a member A is connected to a member B” includes the case in which the member A and the member B are physically directly connected to each other, and the case in which the member A and the member B is indirectly connected via another member that does not affect the electrical connection.

Similarly, “state in which a member C is provided between the member A and the member B” includes the case in which the member A and the member C or the member B and the member C are directly connected, and the case in which the member A and the member C or the member B and the member C are indirectly connected via another member that does not affect the electrical connection.

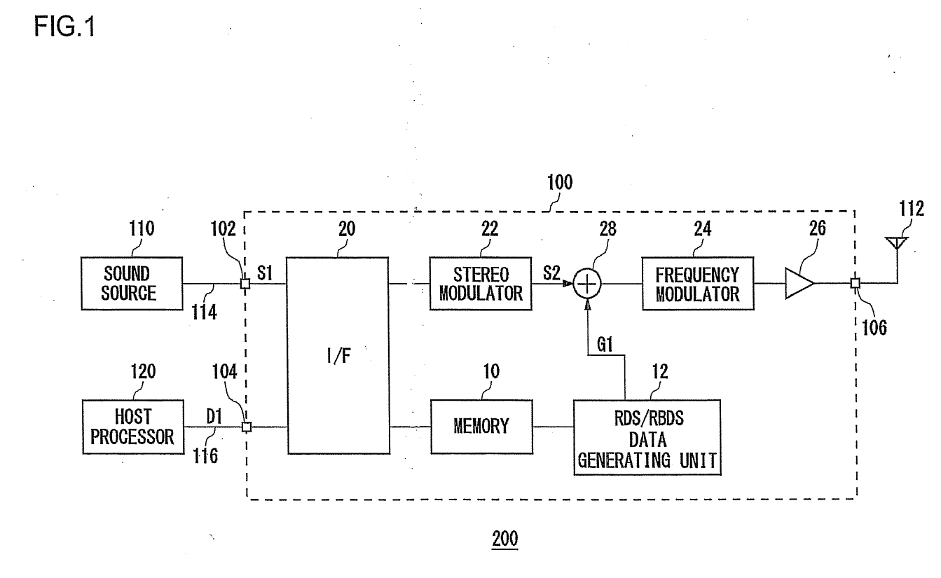

FIG. 1 is a block diagram showing an overall configuration of electronic device 200 having an FM transmitter 100 mounted thereto according to an embodiment of the present invention. This electronic device 200 is, for example, a cellular phone terminal, a radio receiver, or a silicon audio player, having audio reproduction function. The reproduced audio signal can be output from an electroacoustic transducing element such as a speaker or earphones provided to the electronic device 200. In addition, the electronic device 200 modulates a frequency of an audio signal and can transmit the frequency-modulated signal to the outside as a radio wave in order to enable an audio reproduction with high quality of sound. A user can receive the transmitted signal by an external audio player and can reproduce the same with higher quality of sound.

The FM transmitter according to the present embodiment can transmit not only audio data but also character data or the like. For this, the FM transmitter 100 and a host processor 120 generate a signal based on RDS/RBDS. The term of RDS/RBDS means one of RDS and RBDS or both of them.

The electronic device 200 includes a sound source 110, the host processor 120, the FM transmitter 100, and an antenna 112. The sound source 110 and the host processor 120 may be in the same IC.

The sound source 110 outputs an audio signal S1. For example, the audio signal S1 may be a signal obtained by receiving and demodulating a broadcasting wave, or may be a signal obtained by reproducing data stored in a memory. Any methods of generating the audio signal can be employed. The sound source 110 and the FM transmitter 100 are connected with a bus 114 having a predetermined form. For example, the bus 114 is an I2S bus. In this case, the audio signal S1 is transmitted as serial data between the sound source 110 and the FM transmitter 100.

The FM transmitter 100 receives the audio signal S1 from the sound source 110. The FM transmitter 100 includes an interface unit 20, a stereo modulator 22, a frequency modulator 24, a power amplifier 26, a memory 10, and a data generating unit 12, which are monolithically integrated on a single semiconductor substrate as a functional IC (Integrated Circuit). FIG. 1 only shows a main circuit block, and the other blocks are not appropriately described.

The interface unit 20 receives the audio signal S1 from the sound source 110 through an input terminal 102. The interface unit 20 receives the audio signal S1, and outputs the signal to the stereo modulator 22. The stereo modulator 22 performs a stereo modulation to the audio signal S1 so as to generate a stereo composite signal S2.

The detail of the RDS/RBDS is described in NATIONAL RADIO SYSTEMS COMMITTEE, “UNITED STATES RBDS STANDARD”, US, Apr. 9, 1998 or the like, so that it is appreciated that these documents are referred to. The host processor 120 outputs data D1 to be transmitted as RDS/RBDS. The data D1 to be transmitted is not in RDS/RBDS format, but is only text data. The host processor 120 and the FM transmitter 100 are connected through a bus 116 having a predetermined form. For example, the bus 116 is an I2C bus. The interface unit 20 receives the data D1 through the bus 116 and an input terminal 104. The data D1 is additional data to be transmitted from the antenna 112 together with the audio signal S1. The data transmission from the host processor 120 to the FM transmitter 100 is desirably carried out only at the timing when the RDS/RBDS data to be transmitted from the antenna 112 is changed. In this case, the content of the memory 10 is updated only when the data is changed.

The memory 10 is constituted by a resistor, and stores the data D1 received by the interface unit 20. In the RDS/RBDS format, the same data is repeatedly transmitted. The host processor 120 outputs the data, which is a unit of the repetition, together at a time to the FM transmitter 100.

For example, the data D1 includes at least one code of
1) name of broadcasting station
2) character information (Radio Text)
3) Music/Speech
4) Program type
5) PI (Program Identification),
   or a combination thereof. The item 1) includes the “name of broadcasting station” as text data. The music/speech of the item 3) indicates that the data being broadcast is music or speech. The “program type” of the item 4) indicates the genre of the data being broadcast. For example, such settings are made as “0 no definition”, “1 , news”, “3 sports”, “14 jazz”, “17 classics”, or the like. The PI of the item 5) is a code by which the receiver can identify a country.

The data generating unit 12 appropriately rearrange the data D1 stored in the memory 10 so as to generate group data G1 based on the RDS/RBDS format. The generation of the group data G1 is performed at a predetermined timing, for example, at an interval of 87.6 ms. Therefore, the group data G1 is repeatedly output to an adder 28 every 87.6 ms. The adder 28 adds the stereo composite signal S2 from the stereo modulator 22 and the group data G1. The frequency modulator 24 modulates the frequency of a carrier wave with the group data G1 defined as a modulation signal. The modulated signal output from the frequency modulator 24 is amplified by the power amplifier 26, and output to the antenna 112 via an output terminal 106 and a matching circuit (not shown). The data whose frequency is modulated is transmitted from the antenna 112.

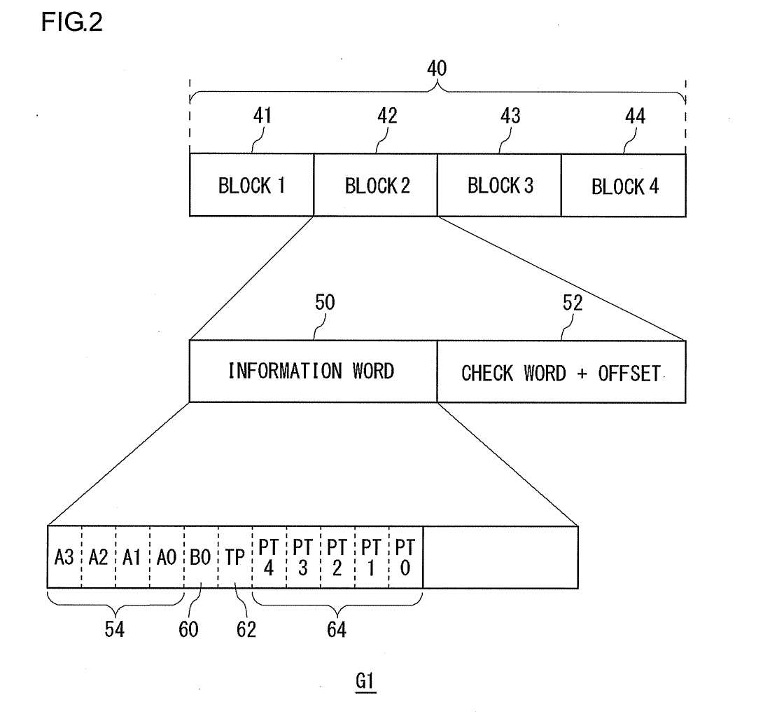

FIG. 2 shows the format of the RDS group data G1. Group data 40 (G1) is composed of 104 bits. The group data G1 is generated every 87.6 ms, and is output from the data generating unit 12. The group data G1 includes four blocks 41 to 44. Each block is composed of 26 bits, and includes 16-bit information word 50 and 10-bit check word 52. The information word of the first block 41 includes PI code.

The information word includes 4-bit (A3 to A0) group type code 54, 1-bit (B0) version code 60, 1-bit (TP) traffic program identification code 62, and 5-bit (PT4 to PT0) program type code 64.

A group type code 54 for designating the usage of this group is allocated to the head of the second block 42 of each group. The program type code 64 and the traffic program identification code 62 are allocated to the predetermined position of the second block 42 of each group.

The check word includes 10 bits that are for detecting and correcting an error generated by the transmission in the transmitter and the receiver. An offset is data for indicating what is the order of the block including the offset. The check word is generated in accordance with a predetermined rule prescribed by a standard.

The remaining data pieces to be transmitted are allocated to the remaining bits. The data of two characters can be transmitted per one block. The data generating unit 12 in FIG. 1 refers to the memory 10 every predetermined timing, that is, every 87.6 ms, so as to generate the group data G1 according to the format shown in FIG. 2.

The FM transmitter 100 thus configured provides the effects described below.

Firstly, the host processor 120 does not need to generate the data of RDS/RBDS format. Therefore, a conventional host processor can be diverted, so that the data to be transmitted may be transmitted to the FM transmitter 100 by utilizing the conventional bus (for example, I2C).

As described above, the data transmitted by RDS/RBDS includes data that is repeatedly transmitted for every block or every group. Accordingly, if the host processor 120 generates the RDS/RBDS data, it is required that all bits of the repeatedly transmitted group data G1 are generated and data having as much as 104 bits is transmitted to the FM transmitter 100 from the host processor 120 through the bus 116 at every 87.6 ms (f=1.19 kHz). Power consumption is produced in the data transmission through the bus, regardless of the form of the bus 116. Therefore, in this system, the same data is retransmitted every time as for the bits that are overlapping-transmitted, with the result that the wasteful power is generated. On the other hand, according to the FM transmitter 100 of the present embodiment, the data to be transmitted is transmitted together at a time to the FM transmitter 100 from the host processor 120, and held in the memory 10. As a result, the data transmission afterwards is unnecessary, whereby the overlapped data transmission is reduced. Accordingly, power consumption is reduced.

Further, it is configured such that at least one code of
1) name of broadcasting station
2) character information (Radio Text)
3) Music/Speech
4) Program type
5) PI (Program Identification),
   is transmitted from the host processor 120, and the data, such as the check word, that can be generated in the FM transmitter 100 is not transmitted from the host processor 120 to the FM transmitter 100, whereby the amount of data transmitted between the FM transmitter 100 and the host processor 120 can be reduced.

The host processor 120 integrally processes the overall electronic device 200. Therefore, when the RDS/RBDS data is generated every 87.6 ms and transmitted to the FM transmitter 100, the processing ability of the host processor 120 is occupied, which is undesirable. In the present embodiment, the load of the host processor 120 can be reduced.

The data transmission through the bus 116 produces noises, and gives adverse affect to the stereo modulation and frequency modulation, resulting in that the property of the FM transmitter 100 might be deteriorated. However, in the present embodiment, the number of times of the data transmission through the bus 116 and the amount of the data can be reduced, so that the property of the FM transmitter 100 can be enhanced.

When the host processor 120 can generate the data of the RDS/RBDS format, a general-purpose mode described below may be mounted to the FM transmitter 100.

The host processor 120 generates the data of the RDS/RBDS format in its inside, and outputs the same to the FM transmitter 100 through the bus 116. The data of the RDS/RBDS format in this case does not include the check word. The data generating unit 12 adds the check word to the data of the RDS/RBDS format received from the host processor 120, and outputs the resultant to the adder 28.

If the general-purpose mode is implemented, various data pieces other than the above-mentioned data pieces can be transmitted. Although the data transmission is carried out through the bus 116 for every 87.6 ms that is the transmission timing, the check word is not transmitted, whereby the power consumption can be reduced.

Subsequently, the automatic tuning technique that tunes the FM transmitter 100 and the receiver by utilizing the RDS/RBDS data will be explained. The automatic tuning technique according to the present embodiment may employ the FM transmitter 100 described above or employ another technique. The following explanation is made on the assumption that the FM transmitter 100 in FIG. 1 is employed.

The technical feature of the RDS/RBDS is that the receiver can make the tuning search by utilizing a predetermined data item (hereinafter simply referred to as a code).

Specifically, when a user sets a predetermined value “news” to a certain code, for example “program type” in a receiver such as a radio tuner, it scans all bands of the broadcasting wave so as to acquire the RDS/RBDS data of the channel that is being broadcast and to decode the same. As a result of the decoding, the channel in which the program type includes the predetermined value of “news” is automatically tuned. When plural channels are present, a user can select one of them.

The automatic tuning technique according to the present embodiment will be explained in detail.

The data generating unit 12 in FIG. 1 sets a predetermined value to a data item (keyword for the tuning search) that can be made as a reference for tuning at the receiver, thereby to generate data of RDS/RBDS format. The frequency modulator 24 modulates the frequency of the group data G1 of the RDS/RBDS format generated at the data generating unit 12, together with the stereo composite signal S2 from the stereo modulator 22, and outputs the frequency-modulated data.

For example, the data item is desirably the “program type”. The value of the program type can be set 32 types that are from “0 no program type” to “31 alarm”. It is desirable that a user of the electronic device 200 can designate which value the program type is set to. In this case, the value of the program type designated by the user via a user interface (not shown) is acquired by the host processor 120. The host processor 120 outputs the value, which is designated as the program type by the user, as the data D1. This program type code is written in the memory 10, whereby the data generating unit 12 can generate data based upon the value designated by the user.

The program type may be preset to the FM transmitter 100 as another embodiment.

The program type may be set independently of the type of the data transmitted from the FM transmitter 100. Specifically, when the transmitted audio signal is “rock”, there is no problem that the value of the program type designated by the user is “news”.

The “music/speech” code may be utilized instead of the program type. In this case, either of “music” or “speech”is set as the value. In this case, the music/speech code may be set independently of the type of the data transmitted from the FM transmitter 100.

In an ordinary using manner, the user of the electronic device 200 is the same as the user of the radio tuner (receiver). Therefore, since the user knows the value set as the program type in the FM transmitter 100, he/she can set this value to the program type of the receiver.

Specifically, the processes described below are executed in the automatic tuning system according to the present embodiment.
(1) A predetermined value is set to a data item (program type, music/speech) of RDS/RBDS that can be set to a reference for tuning in a receiver. This process is mainly executed by the host processor 120 and the data generating unit 12.
(2) The data of the RDS/RBDS format to which the predetermined value is set as the data item is produced. This process is mainly executed by the data generating unit 12.
(3) The frequency of the data of the RDS/RBDS format is modulated, and the frequency-modulated data is output. This process is mainly executed by the frequency modulator 24.

Also, in the receiver,

(A) A radio wave is received, and the data of the RDS/RBDS format is decoded so as to extract and tune a channel whose data item has the predetermined value.

According to the automatic tuning technique according to the present embodiment, the channel in which the program type has the set predetermined value is automatically tuned in the receiver. The RDS/RBDS data in which the program type has the predetermined value is transmitted from the FM transmitter 100. Therefore, a user can tune without inputting the transmission frequency of the FM transmitter 100 to the receiver.

When plural channels are extracted, the user can select the channel of the FM transmitter 100 among them. It is rare that the program by the broadcasting wave has the same value as the program type at the same date and time. Therefore, the user may select only two or three channels at most, so that the user can easily tune compared to the case in which the user has to set the frequency by oneself.

It is general that the program type is set to “0 no program type” in the other FM transmitters other than the FM transmitter 100 according to the present embodiment. Alternatively, the value of the program type may be the data according to the content of the signal transmitted from the FM transmitter 100. On the other hand, the present embodiment is characterized in that the value of the program type is positively set to a certain value, and this value is utilized for the automatic tuning.

While the present invention has been described on the basis of the embodiment, the embodiment only illustrates the principle and application of the present invention, and various modifications and variations in arrangement are possible without departing from the spirit of the present invention defined in claims.

Although the embodiment has been described on the assumption that the FM transmitter 100 shown in FIG. 1 is employed, the present invention related to the automatic tuning is not limited thereto. Specifically, the host processor 120 may generate the RDS/RBDS data, and transmit the data to the FM transmitter 100 every 87.6 ms. In this case too, the modulated signal in which the data item, which is the subject for the tuning search, has a predetermined value, is transmitted from the antenna 112, whereby the automatic tuning is possible.

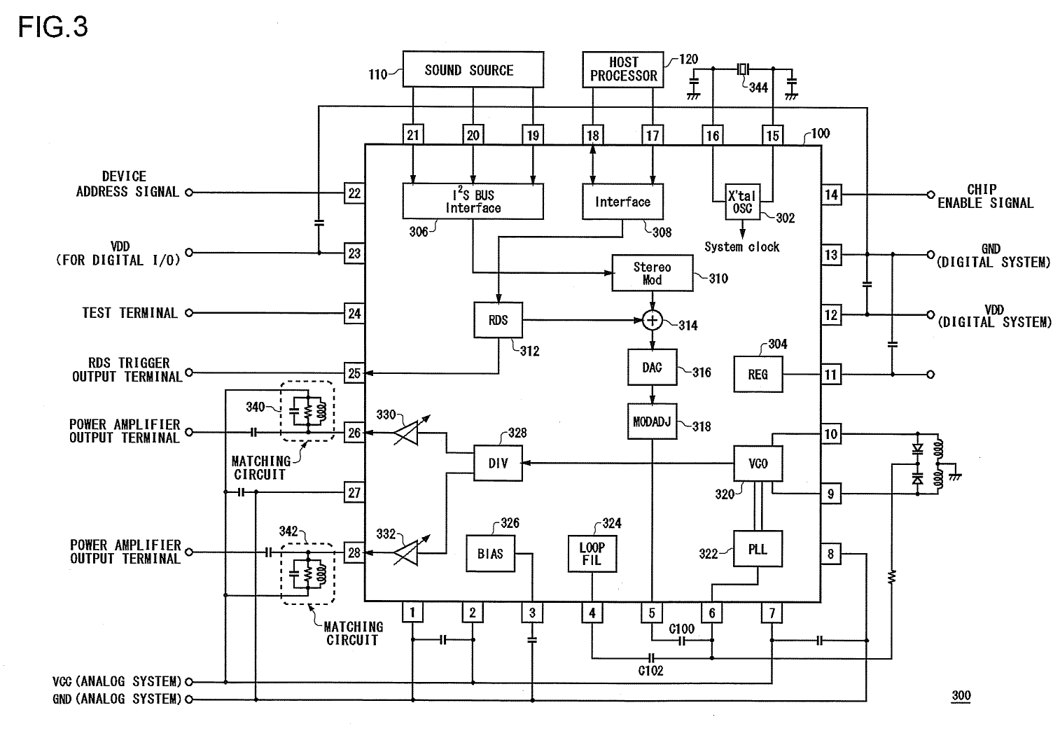

FIG. 3 is a circuit diagram of the FM transmitter 100 and the peripheral circuit. The IC of the FM transmitter 100 includes 1st pin to 28th pin.

A power supply voltage Vcc and a grounding voltage GND to an analog circuit in the FM transmitter 100 are supplied to the 1st pin, 2nd pin, 7th pin, 8th pin, and 27th pin. A power supply voltage Vdd and a grounding voltage GND to the digital circuit are supplied to the 12th pin, 13th pin, and 23rd pin.

A regulator 304 generates a voltage used in an internal logic in the FM transmitter 100. The voltage generated by the regulator 304 is output from the 11th pin.

The sound source 110 is connected to the 19th pin to 21st pin via the I2S bus. The 19th pin is used for data, the 20th pin is used for a clock, and the 21st pin is used for an LR clock. An I2S bus interface unit 306 transmits and receives data to and from the sound source 110.

The host processor 120 is connected to the 17th pin and the 18th pin via the I2C bus. The 17th pin is used for a clock signal, and the 18th pin is used for a data signal.

A quartz vibrator 344 is connected to the 15th pin and the 16th pin. An oscillator 302 provides a system clock.

A chip enable signal is input to the 14th pin. The changeover between a mode in which the FM transmitter 100 normally operates and a power down mode is executed by the chip enable signal. In the power down mode, the internal circuit is shut down, so that the current consumption becomes almost zero, and the internal circuit does not accept an external signal.

A device address selection signal is input to the 22nd pin. The device address signal is set for discriminating an LSI, which is controlled by the common I2C bus, and the FM transmitter 100, when such LSI is present except for the FM transmitter 100. The 24th pin is a test terminal.

The 25th pin is an RDS trigger output terminal. An RDS digital modulator 312 notifies, to the circuit block other than the FM transmitter 100 through the 25th pin, the transmission of the RDS signal to the FM transmitter 100 from the outside.

A stereo modulator 310 accepts the audio signal received from the sound source 110, and stereo-modulates the signal so as to generate a stereo composite signal. The RDS digital modulator 312 sequentially reads out the data from the host processor 120 to execute a binary phase shift keying modulation, performs filtering, and outputs the resultant data. An adder 314 adds the RDS/RBDS data output from the RDS digital modulator 312 to the stereo composite signal.

A DAC 316 performs a digital/analog conversion on the output from the adder 314. The amplitude of the DAC 316 is adjusted by a modulation degree adjusting unit 318, and supplied to a PLL 322 through the 5th pin, an external capacitor C100 and the 6th pin. The 6th pin is connected to a loop filter 324 through the capacitor C102 and the 4th pin (PLL time constant switching terminal). The loop filter 324 is formed by the capacitor C102 connected to the 4th pin and resistor (not shown) in the FM transmitter 100, and the time constant is adjusted by changing the capacitance value of the capacitor C102 or changing the resistance value.

A VCO 320 oscillates with a frequency according to the signal from the PLL, and supplies the FM-modulated signal to a divider 328. A variable capacitance diode and an inductor are connected to the VCO 320 through the 9th pin and the 10th pin.

The FM transmitter 100 has two systems of power amplifier. The divider 328 outputs signals to the power amplifiers 330 and 332. The output from the power amplifier 330 is output to the outside from the 26th pin. A matching circuit 340 is connected to the 26th pin. The output from the power amplifier 332 is output to the outside from the 28th pin. A matching circuit 342 is connected to the 28th pin. Two systems of the power amplifier and the matching circuit are provided, whereby the frequency characteristic can be adjusted in accordance with the load (antenna) of the respective systems.

The corresponding relationship between FIGS. 1 and 3 are shown below.

Interface unit 20: Interface 306, 308

Stereo modulator 22: Stereo modulator 310

Data generating unit 12: RDS 312

Adder 28: Adder 314

Frequency modulator 24: DAC 316, modulation degree adjusting unit 318, loop filter 324, PLL 322, VCO 320

Power amplifier 26: Divider 328, Power amplifier 330, 332

The present specification describes the problems below and the means for solving the problems.

If data of RDS/RBDS format can be carried not only on a broadcasting wave from a broadcasting station but also on a radio wave transmitted from an FM transmitter, this data can be utilized by a receiver, thereby being convenient. In view of this, one embodiment provides an FM transmitter that can transmit data of RDS/RBDS format.

One embodiment of the present invention relates to an FM transmitter that can transmit a signal based on an RDS (Radio Data System) or RBDS (Radio Broadcast Data System) format. This FM transmitter includes an interface unit that receives data to be transmitted through a predetermined bus, from an external host processor, a memory that stores the data received by the interface unit, a data generating unit that generates group data based on a format by utilizing the data stored in the memory, and a frequency modulator that modulates the frequency of the group data generated by the data generating unit and outputs the frequency-modulated data.

According to this embodiment, the host processor may only generate the data to be transmitted, and output the data through the bus without regard to the RDS/RBDS format. The same data is sometimes repeatedly transmitted in the RDS/RBDS. On the other hand, the data is transmitted from the host processor to the FM transmitter only once, whereby the power consumption of the circuit can be reduced.

The data to be transmitted that is received by the interface unit may include at least one code of “name of broadcasting station”, “RT (Radio Text: hereinafter referred to as character information”, “music/speech”, “program type”, and “PI (program identification)”.

The FM transmitter may operate in a general-purpose mode in which the data of RDS format or RBDS format generated at the host processor is received, a check word is added thereto, and the resultant is output.

In this case, when the FM transmitter is connected to the host processor that can generate the data of RDS/RBDS format, the data generated by the host processor can effectively be utilized.

An FM transmitter according to one embodiment may be monolithically integrated on a single semiconductor substrate. The term “monolithically integrated” includes the case in which all the components of a circuit are formed on the semiconductor substrate and the case in which the main components of a circuit are monolithically integrated, wherein some resistors or capacitors may be provided at the outside of the semiconductor substrate for adjusting a circuit constant. These circuits are integrated as a single LSI, whereby the circuit area can be reduced.

Another embodiment of the present invention is electronic device. The electronic device includes a host processor that generates additional data other than an audio signal, and one of the aforesaid FM transmitters that is connected to the host processor through a predetermined bus, accepts the additional data, converts the data into RDS or RBDS format, modulates the frequency of the data, and outputs the resultant.

According to this embodiment, the number of times of the data transmission and data reception between the host processor and the electronic device can be reduced, whereby the power consumption of the electric apparatus can be reduced.

While the preferred embodiments of the present invention have been described using specific terms, such description is for illustrative purposes only, and it is to be understood that changes and variations may be made without departing from the spirit of scope of the appended claims.

What is claimed is:

1. An FM transmitter that can transmit a signal based on an RDS (Radio Data System) format or RBDS (Radio Broadcast Data System) format, comprising:
a data generating unit that sets a predetermined value to a data item, which can be made as a reference for tuning at a receiver side, and generates data of an RDS/RBDS format; and
a frequency modulator that modulates the frequency of the data of the RDS/RBDS format generated at the data generating unit and outputs the frequency-modulated data.

2. An FM transmitter according to claim 1, wherein
the data item is a program type.

3. An FM transmitter according to claim 2, wherein
the program type is set independently of the type of the data transmitted from the FM transmitter.

4. An FM transmitter according to claim 1, wherein
the data item is a music/speech code

5. An FM transmitter according to claim 4, wherein
the music/speech code is set independently of the type of the data transmitted from the FM transmitter.

6. An FM transmitter according to claim 1, wherein
the data generating unit sets the predetermined value according to a designation by a user.

7. An FM transmitter according to claim 1, which is monolithically integrated on a single semiconductor substrate.

8. An electronic device comprising:
the FM transmitter according to claim 1; and
a host processor that is connected to the FM transmitter through a predetermined bus, acquires the predetermined value designated by the user, and transmits the predetermined value to the FM transmitter, wherein
the FM transmitter sets the predetermined value designated by the user to the data item.

9. A method for automatic tuning includes:
in an FM transmitter,
setting a predetermined value to a data item of RDS/RBDS that can be set to a reference of tuning in a receiver;
generating data of RDS/RBDS format to which the predetermined value is set as the data item; and
outputting the data of the RDS/RBDS format with the frequency modulated, and
in an FM receiver,
receiving a radio wave, and
decoding data of RDS/RBDS format so as to extract and tune a channel whose data item, which can be made to be a reference for tuning, has a predetermined value.
